(19) United States
(12) Patent Application Publication
(10) Pub. No.: US 2026/0301551 A1
(43) Pub. Date: Oct. 1, 2026

(54) HAPTIC PRESENTATION DEVICE, METHOD FOR CONTROLLING THE SAME, AND PROGRAM

(71) Applicant: Sony Interactive Entertainment Inc., Tokyo (JP)

(72) Inventor: Yoichi NISHIMAKI, Tokyo (JP)

(21) Appl. No.: 19/474,094

(22) PCT Filed: Apr. 18, 2023
(86) PCT No.: PCT/JP2023/015487

§ 371 Date: Oct. 9, 2025

(51) Int. Cl. G08B 6/00

(52) U.S. Cl. CPC G08B 6/00

(57) ABSTRACT

A haptic presentation device includes a holding unit that holds a user's finger from at least two directions and a haptic presentation unit that is disposed inside the holding unit at a position where the haptic presentation unit can come in contact with at least one of areas including at least the pad side, left side, right side, and nail side of the user's finger held by the holding unit, and that presents a sense of force to the area with which the haptic presentation unit is in contact.

### TECHNICAL FIELD

The present invention relates to a haptic presentation device, a control method for the haptic presentation device, and a program.

### BACKGROUND ART

A technique for presenting a sense of force (haptics) by applying vibrations or motions to a user's fingertips or the like has been known.

### SUMMARY

### Technical Problem

Conventional haptic presentation devices present a sense of force to the fingertips of a user, and the types of sense of force that can be presented are limited.

The present invention has been made in consideration of the above-mentioned situation, and one of its objectives is to provide a haptic presentation device, a control method for a haptic presentation device, and a program that can increase the types of sense of force that can be presented.

### Solution to Problem

In order to solve the problem of the above-mentioned conventional example, according to an aspect of the present invention, there is provided a haptic presentation device including a holding unit that holds a user's finger from at least two directions and a haptic presentation unit that has a movable member being movable in three axial directions perpendicular to one another and being disposed inside the holding unit at a position where the movable member can come in contact with the user's finger held by the holding unit, and that presents a sense of force to an area of the user's finger with which the movable member is in contact.

### Advantageous Effects of Invention

According to the present invention, the haptic presentation unit presents a sense of force at a position where it can come in contact with at least one of areas including at least the pad side, left side, right side, and nail side of the held finger. This makes it possible to increase the types of sense of force that can be presented.

### BRIEF DESCRIPTION OF DRAWINGS

FIG. 1 is a schematic explanatory diagram illustrating an example of the configuration of a haptic presentation device according to an embodiment of the present invention.

FIG. 2 is a schematic configuration diagram illustrating an example of a haptic presentation unit of the haptic presentation device according to the embodiment of the present invention.

FIG. 3 is an explanatory diagram illustrating an example of the state where haptic presentation is performed by the haptic presentation device according to the embodiment of the present invention.

FIG. 4 is a schematic configuration diagram illustrating an example of the arrangement of the haptic presentation unit and a sensor unit of the haptic presentation device according to the embodiment of the present invention.

FIG. 5 depicts explanatory diagrams illustrating examples of the arrangement of movable members in the haptic presentation unit of the haptic presentation device according to the embodiment of the present invention.

FIG. 6 is an explanatory diagram illustrating an example of haptic presentation by the haptic presentation device according to the embodiment of the present invention.

FIG. 7 is an explanatory diagram illustrating another example of the haptic presentation by the haptic presentation device according to the embodiment of the present invention.

### DESCRIPTION OF EMBODIMENT

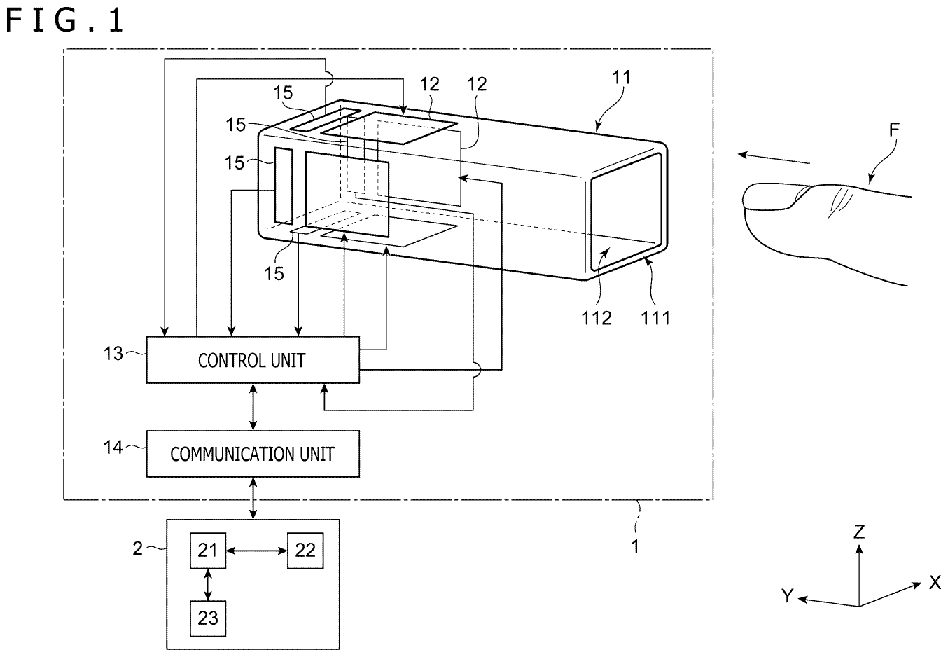

An embodiment of the present invention will be described with reference to the drawings. As illustrated in FIG. 1, a haptic presentation device 1 according to the embodiment of the present invention includes a finger holding unit 11, haptic presentation units 12, a control unit 13, and a communication unit 14. In addition, the haptic presentation device 1 may further include sensor units 15. It should be noted that, in the following description and drawings, the size, size ratio, etc., of each unit are merely examples and may be changed as appropriate.

Further, the haptic presentation device 1 is connected so as to be capable of communicating with an information processing apparatus 2 in a wired or wireless manner.

The finger holding unit 11 of the haptic presentation device 1 holds a user's finger from at least two directions (e. g., up-down and right-left directions). As illustrated in FIG. 1, for example, the finger holding unit 11 has a substantially rectangular tubular shape and includes an end face 111 in the longitudinal direction (Y-axis direction) with an opening 112 formed therein.

A user inserts a tip portion of a finger F (e.g., a portion between the first joint and the tip) into the finger holding unit 11 through this opening 112. In the following example (as illustrated in FIG. 1), the direction from the pad side (the side of the fingertip corresponding to the palm side) of the user's finger held by the finger holding unit 11 to the nail side is assumed to be a positive direction of a Z axis, and the direction from the left side to the right side of the user's finger (as viewed from the user) is assumed to be a positive direction of an X axis. In addition, the direction from the proximal to distal end of the user's finger is assumed to be a positive direction of a Y axis. Further, a coordinate system represented by the X, Y, and Z axes will be referred to as a device coordinate system hereinafter.

The haptic presentation unit 12 is disposed inside the finger holding unit 11 at a position where the haptic presentation unit 12 can come in contact with at least one of areas including at least the pad side, left side, right side, and nail side of the user's finger held by the finger holding unit 11. Further, the haptic presentation unit 12 presents a sense of force to the area with which the haptic presentation unit 12 comes in contact.

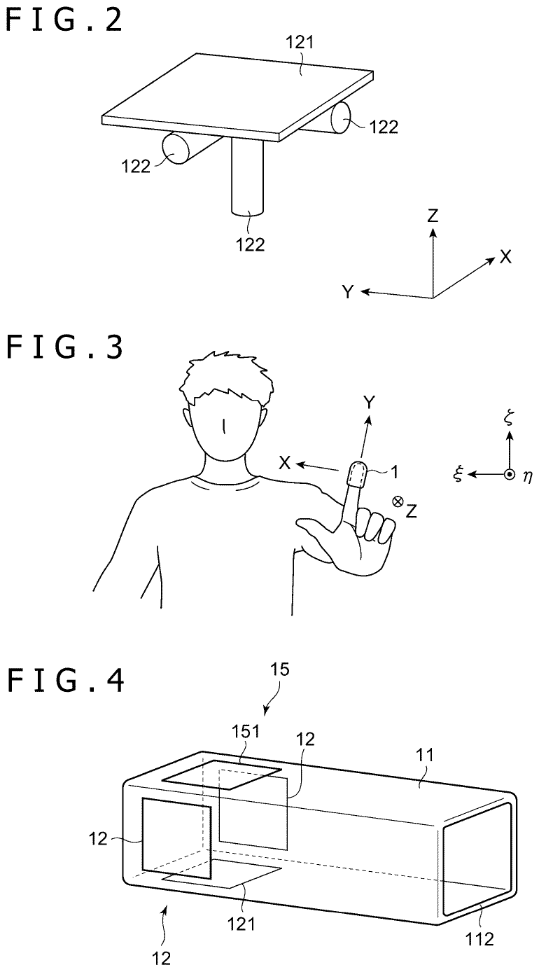

In an example of the present embodiment, each of the haptic presentation units 12 includes a plate 121 and a drive section 122 as illustrated in FIG. 2. The example in FIG. 2 illustrates the haptic presentation unit 12 disposed on the pad side of the finger.

Here, the plate 121 corresponds to a movable member according to the present invention and is disposed inside the finger holding unit 11 at a position where the plate 121 comes in contact with the pad side of the user's finger when the user's finger is inserted into the finger holding unit 11, for example. Further, the plate 121 is controlled by the drive section 122 to move in two or more directions including at least the normal direction of the plate 121 (for example, the Z-axis direction for the plate 121 that comes in contact with the pad side of the user's finger), preferably in three directions of the X, Y, and Z axes.

The drive section 122 includes a plurality of linear actuators that move the plate 121 within a predetermined movable range in two or more axial directions perpendicular to each other, such as two or more axial directions including the normal direction of the plate 121 among the X-axis, Y-axis, and Z-axis directions of the device coordinate system.

That is, for the plate 121 disposed to come in contact with the pad side or nail side of the user's finger when the user's finger is inserted into the finger holding unit 11, the linear actuators of the drive section 122 are provided such that the relevant plate 121 can move at least in the direction toward the pad side of the user's finger, which is the normal direction of the plate 121, i.e., in the Z-axis direction. Also, for the plate 121 disposed to come in contact with the left or right side of the user's finger, the linear actuators are provided such that the relevant plate 121 can move at least in the direction toward the side of the user's finger, which is the normal direction of the plate 121, i.e., in the X-axis direction. This allows at least one movable member to present a pressing force to the user's finger.

Further, in an example of the embodiment, the linear actuators of the drive section 122 are arranged such that they can move the corresponding plate 121 within a predetermined movable range in three axial directions perpendicular to one another (specifically, the X-axis, Y-axis, and Z-axis directions of the device coordinate system). As such linear actuators, those widely known as multi-axis actuators can be adopted, and therefore, the detailed description will be omitted here.

In addition, when the haptic presentation device 1 is initialized, such as when the power is turned on, the drive section 122 may move the plate 121 to the middle of its movable range, such as a position of 50 when the movable range of the plate 121 in a certain axial direction is from 0 to 100.

Further, after the user's finger is inserted into the finger holding unit 11, the drive section 122 may move the plate 121 by a predetermined amount in the normal direction (direction of pressing the user's finger). Here, the predetermined amount may be a shift amount to a position where the torque required to move the plate 121 is a predetermined magnitude. In this way, the user's finger can be pressed against an inner surface of the finger holding unit 11, and the haptic presentation device 1 can thus be fixed to the user's finger.

Further, the drive section 122 may move the plate 121 via a clutch. In this way, excessive pressure can be prevented from being applied to the user's finger.

The control unit 13 is a program-controlled device such as a microcomputer and operates according to a program stored in a storage unit which is not illustrated. This program may be provided by being stored in a computer-readable and non-transitory recording medium and may then be stored in a storage unit such as a memory accessed by the control unit 13. In the example of the present embodiment, the control unit 13 drives the drive section 122 of the haptic presentation unit 12 according to an instruction (haptic presentation instruction) received from the information processing apparatus 2 via the communication unit 14, to move the plate 121 in two or more axial directions including at least the normal direction of the plate 121.

The communication unit 14 communicates with the information processing apparatus 2, and when receiving an instruction from the information processing apparatus 2, outputs the instruction to the control unit 13. Further, the communication unit 14 also outputs, to the information processing apparatus 2, transmission target information output by the control unit 13 as a target for transmission.

The information processing apparatus 2 is a computer device such as a home game console, a personal computer, a tablet terminal, or a smartphone, and includes a processor 21, a storage unit 22, and a communication unit 23. The processor 21 executes a predetermined program stored in the storage unit 22. In the process of executing the program, the processor 21 generates a haptic presentation instruction indicating a sense of force to be presented by the haptic presentation device 1, and sends the instruction to the haptic presentation device 1 via the communication unit 23.

### Detection of Finger Position and Posture

In an example of the present embodiment, at least either the haptic presentation device 1 or the information processing apparatus 2 detects information regarding the position and posture of the haptic presentation device 1 and their changes over time, for example (hereinafter, for convenience, referred to as posture information). To be specific, in an example of the present embodiment, as a coordinate system expressing the posture information, a coordinate system (called a world coordinate system) is set such that the normal direction of a floor surface on which the user is standing (or sitting) (i.e., the direction of gravity) is a ζ axis (its positive direction is upward), the front direction of the user (normal direction of a frontal plane of the user; its positive direction is a direction in front of the user) is an n axis, and the right-left direction of the user (normal direction of a sagittal plane of the user; its positive direction is a direction from left to right as seen from the user) is a ξ axis.

In the case where the haptic presentation device 1 detects its own posture information in the world coordinate system, the haptic presentation device 1 includes the sensor units 15 including acceleration sensors that detect the acceleration in the respective X-axis, Y-axis, and Z-axis directions. In this case, while assuming that the user is pointing forward with the finger wearing the haptic presentation device 1 without moving the finger (it is sufficient to instruct the user to take such a hand posture) at the time of startup, the control unit 13 of the haptic presentation device 1 detects the direction of gravity (ζ-axis direction) from the output of the acceleration sensors in the respective X-axis, Y-axis, and Z-axis directions (initialization process). In addition, in this initialization process, the control unit 13 may further set, as the ξ-axis direction, the direction of the X-axis projected onto a plane normal to the detected ζ-axis direction, and set the direction perpendicular to the ξ axis in the same plane as the n axis.

After the initialization process (at least after detecting the ζ-axis direction), the haptic presentation device 1 is assumed to estimate the movement 4 the haptic presentation device 1 and its rotation on the spot (the posture of the haptic presentation device 1) from the output of the acceleration sensors in the respective X-axis, Y-axis, and Z-axis directions, and estimate the ζ-axis direction (and the ξ-axis and η-axis directions) at each point in time after the initialization process.

Meanwhile, in the case where the information processing apparatus 2 acquires posture information of the haptic presentation device 1, the information processing apparatus 2 is equipped with a camera (not illustrated) that captures an image of the user wearing the haptic presentation device 1, for example, and acquires, from the image captured by this camera, the posture information of the haptic presentation device 1 (information regarding the position in the ξ, η, and ξ coordinate system, information regarding the posture with the Y-axis direction represented by a vector in the ξ, η, and ζ coordinate system, and/or information regarding the posture with the ζ-axis direction represented in the X, Y, and Z coordinate system, for example).

As the method of acquiring the posture information of the haptic presentation device 1 by the haptic presentation device 1 itself or the information processing apparatus 2 as described above, a variety of widely known methods including the one exemplified here can be adopted, and therefore, the further detailed description will be omitted here. Also, since the method of conversion between the world coordinate system and the device coordinate system is widely known, the description will be omitted here.

### Example of Control

Next, an example of drive control of the drive section 122 by the control unit 13 of the haptic presentation device 1 and the information processing apparatus 2 will be described. In the following example, the drive section 122 is capable of being driven and controlled in three axial directions, namely, the X-axis, Y-axis, and Z-axis directions.

The processor 21 of the information processing apparatus 2 acquires posture information of the haptic presentation device 1 when receiving, from the haptic presentation device 1, information detected and estimated by the control unit 13 of the haptic presentation device 1 or when detecting the information by the information processing apparatus 2 itself.

Then, when the acquired posture information satisfies a condition predetermined by the program being executed, the processor 21 sends a haptic presentation instruction designated in association with this condition to the haptic presentation device 1.

For example, this condition may be that the absolute value of the difference in angle between the Y-axis direction and the ζ-axis direction is less than a predetermined threshold value (the Y-axis direction is substantially parallel to the ζ-axis direction). To be specific, as illustrated in FIG. 3, in the state where the user points upward with the tip of the finger (the index finger of the left hand in FIG. 3) wearing the haptic presentation device 1, the absolute value of the difference in angle between the Y-axis direction and the ζ-axis direction is less than a predetermined threshold value.

In association with this condition, a haptic presentation instruction to drive the drive section 122 in a direction opposite to the movement in the X-axis or Z-axis direction in response to the acceleration in the X-axis or Z-axis direction is assumed to be set, for example.

Accordingly, the information processing apparatus 2 sends this haptic presentation instruction to the haptic presentation device 1.

When the user who is pointing upward with the tip of the finger wearing the haptic presentation device 1 as illustrated in FIG. 3 moves the finger in the right-left direction (for example, in the positive direction of the X axis) (as if the user was tracing a wall with the finger), the control unit 13 of the haptic presentation device 1 causes the drive section 122 to move the plate 121 in contact with the pad of the user's finger in the direction opposite to the movement of the user's finger (in the negative direction of the X axis).

In this way, when the user starts moving his/her finger, the user is presented a sense of force that causes the user to feel as if force acting against the movement of the finger (friction from the wall) was being applied to the fingertip. In other words, the user feels as if the user was moving his/her finger with the fingertip touching something like a wall. Note that, in the case where a sense of force is presented by using a device with a limited amount of movement, such as the plate 121, the control unit 13 may repeatedly refer to the output of the acceleration sensors of the sensor units 15. Then, only when the acceleration sensor in the X-axis or Z-axis direction detects acceleration exceeding a predetermined value, the control unit 13 may control the drive section 122 to move the plate 121 in a direction opposite to the direction of the acceleration. When the acceleration sensor in the X-axis or Z-axis direction does not exceed the predetermined value, the control unit 13 may control the drive section 122 to return the plate 121 to its original position (initial position).

### Another Example of Control

In another example, the user may wear the haptic presentation devices 1 on a plurality of fingers, respectively. For example, in the case where the user is wearing the respective haptic presentation devices 1 on the thumb and the index finger, the processor 21 of the information processing apparatus 2 acquires pieces of posture information of the respective haptic presentation devices 1. Then, when the acquired posture information satisfies a condition predetermined by the program being executed, the processor 21 sends a haptic presentation instruction designated in association with this condition to the corresponding haptic presentation device 1.

For example, this condition may be that a cube-shaped area (hereinafter referred to as a virtual area) defined in the world coordinate system includes information regarding the position indicated by the posture information and that the negative Z-axis direction is directed to the inside of the virtual area. In association with this condition, a haptic presentation instruction to present a reaction force against the negative Z-axis acceleration and present force acting in the negative ζ-axis direction against the acceleration in the positive ζ-axis direction is set, for example.

According to this example, it is possible to present a sense of force that gives a feeling as if there were a virtual cube in the above cubic virtual area. That is, when the user moves the thumb and the index finger so as to sandwich the virtual area with the pads of these fingers from the right and left (in the direction perpendicular to the direction of gravity) and then the positions of the haptic presentation devices 1 attached to the respective fingers enter the virtual area, the above condition is satisfied.

Then, according to the haptic presentation instruction received from the information processing apparatus 2, the control unit 13 of the haptic presentation device 1 controls the drive section 122 to move the plate 121 in contact with the pad of the user's finger in the positive direction of the Z axis in response to the acceleration (negative Z-axis acceleration) that is caused by the user moving his/her finger further into the virtual area. This presents a sense of force that causes the user to feel as if the user were sandwiching a virtual cube in the virtual area.

When the user who is in the above state further moves his/her finger in the direction opposite to the direction of gravity (makes such a movement as to lift the virtual cube), acceleration occurs in the positive direction of the ζ axis. Then, on the basis of the haptic presentation instruction received from the information processing apparatus 2, the control unit 13 drives the drive section 122 in the X-axis, Y-axis, and Z-axis directions to move the plate 121 in contact with the pad of the user's finger in the negative direction of the ζ axis. This causes the user to feel as if the virtual cube was being drawn by gravity (had weight).

### Fixing to a Finger

In addition, in an example of the present embodiment, the haptic presentation device 1 further includes a force sensor that detects force applied thereto. The force sensor is disposed in an area which is at least one of areas including at least the pad side, left side, right side, and nail side of the user's finger held by the finger holding unit 11 and which is on a side opposite to the area where the haptic presentation unit 12 is disposed.

In this example, as illustrated in FIG. 4, the sensor unit 15 of the haptic presentation device 1 includes a force sensor 151 disposed on a side opposite to the plate 121 of at least one of the haptic presentation units 12. In the example in FIG. 4, the force sensor 151 is disposed on a side opposite to the plate 121 in contact with the pad side of the user's finger.

After the user inserts his/her finger into the finger holding unit 11, the haptic presentation device 1 may move the plate 121 of the haptic presentation unit 12 which is disposed at a position opposite to the force sensor 151, by a predetermined amount in the normal direction of the plate 121 (direction of pressing the user's finger), and set the position as the initial position. In this example, the predetermined amount is the amount of movement at the time when the magnitude of the force applied to the force sensor 151 reaches a predetermined threshold value. This makes it possible to reliably press the user's finger against the inner surface of the finger holding unit 11 with a force of the threshold value and fix the haptic presentation device 1 to the user's finger. Further, when the threshold value is set to an experimentally appropriate value, excessive pressure can be prevented from being applied to the user's finger. In this example, a sense of force generated when the user's finger is pressed is the initial value of a sense of force to be presented.

### Another Example of a Method of Fixing to a Finger

Note that the method of fixing the haptic presentation device 1 to a finger is not limited to the method using the haptic presentation unit 12. For example, instead of or in addition to the fixing method using the haptic presentation unit 12 described above, an O-ring made of an elastic material such as rubber may be disposed on the periphery of the opening 112. According to this example, when the user's finger is inserted through the opening 112, the outer periphery of the finger is tightened by the restoring force of the O-ring, and the haptic presentation device 1 is thus fixed to the user's finger.

### Example With a Plurality of Plates

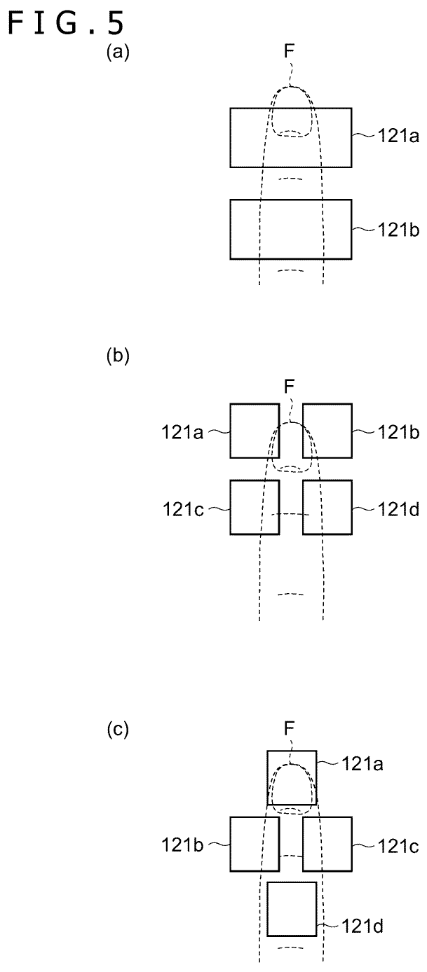

Further, in the present embodiment described thus far, the haptic presentation unit 12 has a pair of plate 121 and drive section 122, but the present embodiment is not limited to this. The haptic presentation device 1 according to an example of the present embodiment may include at least one haptic presentation unit 12 that presents a sense of force to at least one of the areas including at least the pad side, left side, right side, and nail side of the user's finger held by the finger holding unit 11, and at least any one of the haptic presentation units 12 may include a plurality of plates 121a, 121b, . . . (each of which corresponds to a movable member) as exemplified in FIG. 5.

In this case, the haptic presentation unit 12 including the plurality of plates 121a, 121b, . . . may have drive sections 122a, 122b, corresponding to the respective plates 121a, 121b, . . . and may be able to move the plates 121 in different directions.

In addition, the plurality of plates 121a, 121b, . . . may be disposed in a row from the distal side to proximal side of the user's finger F as illustrated in FIG. 5(a), may be disposed in a matrix pattern such as 2×2 as in FIG. 5(b), or may be disposed in a staggered pattern as in FIG. 5(c) etc.

In the case where the haptic presentation unit 12 has a plurality of pairs of plates 121 and drive sections 122 as described above, the information processing apparatus 2 sends out haptic presentation instructions indicating drive modes (movement directions, movement amounts, etc.) of the drive sections 122 of the respective pairs, and the control unit 13 drives and controls the respective drive sections 122 according to the drive modes indicated by the haptic presentation instructions.

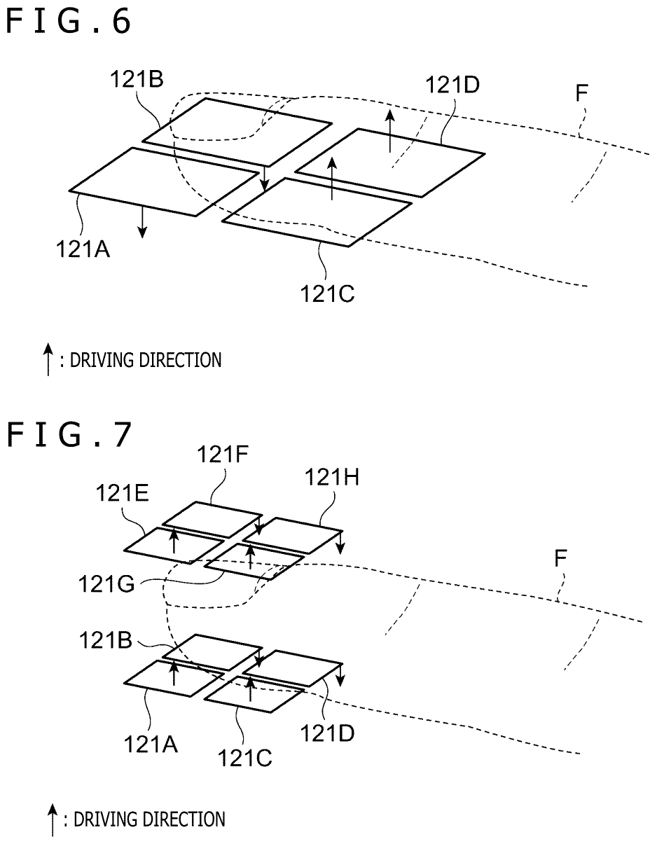

For example, when the plates 121 in contact with the pad side of the user's finger F are arranged as illustrated in FIG. 5(b), two plates 121A and 121B on the fingertip side (distal side) are moved in a direction away from the finger along the Z-axis direction while two plates 121C and 121D on the proximal side are moved in a direction of pressing the finger along the Z-axis direction (FIG. 6), so that the user can be presented with a sense of force that gives a feeling as if the user were pushing and rotating a spherical object with the finger F.

Further, similarly, when the plates 121 in contact with the pad side of the user's finger and the plates 121 in contact with the nail side of the user's finger F are both arranged as illustrated in FIG. 5(b), a sense of force that gives a feeling as if the finger F were rotating clockwise can be presented to the user by moving the plates 121 as follows:
plates 121A and 121C which are on the pad side of the user's finger F and on the left side as seen from the user are moved in a direction of pressing the finger along the Z-axis direction,
plates 121B and 121D which are on the pad side of the user's finger F and on the right side as seen from the user are moved in a direction away from the finger along the Z-axis direction,
plates 121E and 121G which are on the nail side of the user's finger F and on the left side as seen from the user are moved in a direction away from the finger along the Z-axis direction, and
plates 121F and 121H which are on the nail side of the user's finger F and on the right side as seen from the user are moved in a direction of pressing the finger along the Z-axis direction (FIG. 7).

Note that, in the case where the haptic presentation unit 12 includes a plurality of plates 121, the plates 121 have the same size and shape in FIGS. 6 and 7, but the plurality of plates 121 included in the haptic presentation unit 12 may have different sizes. For example, the plate 121 disposed on the distal side of the user's finger may be relatively larger than the plate 121 disposed on the proximal side. In other words, the plate 121 may be larger in size as the plate 121 is located closer to the distal end.

Moreover, in the case where the haptic presentation unit 12 has the plurality of pairs of plates 121 and drive sections 122 as described above, the plates 121 may be disposed on the proximal and distal sides of the user's finger. In this instance, the haptic presentation device 1 may be fixed to the user's finger by the proximal plate 121, and the distal plate 121 may be used solely for presenting a sense of force based on the haptic presentation instruction issued by the information processing apparatus 2.

In this example, the force sensor 151 is further disposed at a position opposite to the proximal plate 121 with the user's finger interposed therebetween. After the user inserts the user's finger into the finger holding unit 11, the proximal plate 121 of the haptic presentation unit 12 disposed at a position opposite to the force sensor 151 is then moved by a predetermined amount in its normal direction (direction of pressing the user's finger). Here, the predetermined amount is the amount of movement at the time when the magnitude of the force applied to the force sensor 151 reaches a predetermined threshold value.

According to this example, the plate 121 disposed on the distal side of the user's finger is not used for fixing the haptic presentation device 1 to the finger and can be used solely for presenting a sense of force based on the instruction from the information processing apparatus 2, thereby making it possible to present the sense of force relatively efficiently.

### Example Using Something Other Than an Actuator

Further, as has been described thus far, the haptic presentation unit 12 has the plate 121 and the drive section 122 including the linear actuators, but the present embodiment is not limited to this example. For example, the plate 121 does not need to be flat. The plate 121 may have a surface that follows the curved surface of a finger, and the surface of the plate 121 may be brought into contact with the user's finger.

Further, the drive section 122 does not have to have the linear actuators and may have any components such as linear motors that can move a movable member such as the plate 121 in at least two or more of the X-axis, Y-axis, and Z-axis directions (preferably three axial directions perpendicular to one another).

In addition, the drive section 122 may have a parallel link mechanism for movably supporting the plate 121 with a number of linear actuators. In this case, the haptic presentation unit 12 is what is called a motion table.

Moreover, the haptic presentation unit 12 may be made of a material capable of changing its shape by air pressure or the like, such as a shape-memory alloy. In this case, the shape of the material is changed such that a desired sense of force can be presented.

In an example, the haptic presentation unit 12 may include a roller (a roller having a rotation axis in the Y-axis direction) that can be rotated infinitely in one axis direction (e.g., the X-axis direction), a motor that rotates this roller, and two linear actuators that move this roller parallel to the Y-axis direction and the Z-axis direction, respectively. In this case, it becomes possible to continuously present, in the X-axis direction, a sense of force corresponding to the movement of the user's finger in the X-axis direction (e.g., a sense of force that resists the movement or a sense of force involving sliding force that assists the movement).

### Effects of the Embodiment

According to the present embodiment, the user's finger is held in the tubular finger holding unit 11, for example, and there are provided the haptic presentation units 12 disposed inside the finger holding unit 11 at the respective positions where the haptic presentation units 12 can come in contact with any of, preferably two or more of, the areas including the pad side, left side, right side, and nail side of the finger. Each of the haptic presentation units 12 presents a sense of force to the area in contact therewith. This makes it possible to present different senses of force to a plurality of areas of the user's finger. Also, for example, by presenting a strong sense of force in the direction of pressing the finger from the haptic presentation unit 12 on one side, such a sense of force that the finger is pressed against the haptic presentation unit 12 or the inner surface of the finger holding unit 11 on the opposite side can be presented. In such a manner, it is possible to increase the types of sense of force that can be presented.

In addition, by driving (moving) the movable member (or some of them in the case where there are a plurality of movable members) of the haptic presentation unit 12 in the direction of pressing the finger within the finger holding unit 11, the finger held in the finger holding unit 11 can be prevented from slipping out of the finger holding unit 11, and a sense of force can be presented while the haptic presentation device 1 is fixed to the finger.

### REFERENCE SIGNS LIST

1: Haptic presentation device
2: Information processing apparatus
11: Finger holding unit
12: Haptic presentation unit
13: Control unit
14: Communication unit
15: Sensor unit
21: Processor
22: Storage unit
23: Communication unit
111: End face
112: Opening
121: Plate
122: Drive section
151: Force sensor

1. A haptic presentation device comprising:
a holding unit configured to hold a user's finger from at least two directions; and
a haptic presentation unit comprising a movable member being movable in three axial directions perpendicular to one another and being disposed inside the holding unit at a position where the movable member is configured to come in contact with the user's finger held by the holding unit, and present a sense of force to an area of the user's finger with which the movable member is in contact.

2. The haptic presentation device according to claim 1, wherein the haptic presentation unit comprises:
the movable member disposed inside the holding unit at a position where the movable member comes in contact with at least one of areas including at least a pad side, a left side, a right side, and a nail side of the user's finger held by the holding unit.

3. The haptic presentation device according to claim 1, wherein the haptic presentation unit includes a plurality of haptic presentation units disposed inside the holding unit at positions where respective haptic presentation units are configured.

4. The haptic presentation device according to claim 3, wherein
each respective haptic presentation unit comprises at least one movable member.

5. The haptic presentation device according to claim 4, wherein
at least any one of the respective haptic presentation units comprises a plurality of movable members that are movable in different directions.

6. The haptic presentation device according to claim 5, wherein
the plurality of movable members of the respective haptic presentation unit are movable members having different sizes.

7. The haptic presentation device according to claim 6, wherein
sizes of the plurality of movable members are set such that a movable member is larger in size as the movable member is located closer to a distal end.

8. The haptic presentation device according to claim 1, further comprising:
a force sensor configured to detect force applied to the force sensor.

9. A haptic presentation device comprising:
a holding unit configured to hold a user's finger from at least two directions;
a haptic presentation unit disposed inside the holding unit at a position where the haptic presentation unit is configured to come in contact with at least one of areas including at least a pad side, a left side, a right side, and a nail side of the user's finger held by the holding unit, and present a sense of force to an area with which the haptic presentation unit is in contact;
a force sensor configured to detect force applied to the force sensor, the force sensor being disposed in an area that corresponds to at least one of the areas including at least the pad side, the left side, the right side, and the nail side of the user's finger held by the holding unit and that is on a side opposite to an area where the haptic presentation unit is disposed; and
a control unit configured to
use an output of the force sensor to set an initial value of the sense of force to be presented by the haptic presentation unit disposed in contact with [[the]]an area on a side corresponding to the force sensor,
accept information indicating the sense of force to be presented, and
control the haptic presentation unit on a basis of the accepted information to present the sense of force to the position of the user's finger held by the holding unit where the haptic presentation unit is in contact with the user's finger.

10. A method for controlling a haptic presentation device,
the haptic presentation device including
a holding unit configured to hold a user's finger from at least two directions,
a haptic presentation unit disposed inside the holding unit at a position where the haptic presentation unit is configured to come in contact with at least one of areas including at least a pad side, a left side, a right side, and a nail side of the user's finger held by the holding unit, and present a sense of force to an area with which the haptic presentation unit is in contact, and
a force sensor configured to detect force applied to the force sensor, the force sensor being disposed in an area that corresponds to at least one of the areas including at least the pad side, the left side, the right side, and the nail side of the user's finger held by the holding unit and that is on a side opposite to an area where the haptic presentation unit is disposed,
the method comprising:
by the haptic presentation device, using an output of the force sensor to set an initial value of the sense of force to be presented by the haptic presentation unit disposed in contact with the area on a side corresponding to the force sensor;
accepting information indicating the sense of force to be presented; and
controlling the haptic presentation unit on a basis of the accepted information to present the sense of force to the position of the user's finger held by the holding unit where the haptic presentation unit is in contact with the user's finger.

11. A non-transitory, computer-readable storage medium having a program stored thereon, the program, when executed, configured to control a haptic presentation device,
the haptic presentation device including
a holding unit configured to hold a user's finger,
a haptic presentation unit disposed inside the holding unit at a position where the haptic presentation unit is configured to come in contact with at least one of areas including at least a pad side, a left side, a right side, and a nail side of the user's finger held by the holding unit, and configured to present a sense of force to an area with which the haptic presentation unit is in contact, and
a force sensor configured to detect force applied to the force sensor, the force sensor being disposed in an area that corresponds to at least one of the areas including at least the pad side, the left side, the right side, and the nail side of the user's finger held by the holding unit and that is on a side opposite to an area where the haptic presentation unit is disposed,
wherein controlling the haptic presentation device comprises:
using an output of the force sensor to set an initial value of the sense of force to be presented by the haptic presentation unit disposed in contact with the area on a side corresponding to the force sensor;
accepting information indicating the sense of force to be presented; and
controlling the haptic presentation unit on a basis of the accepted information to present the sense of force to the position of the user's finger held by the holding unit where the haptic presentation unit is in contact with the user's finger.

12. The haptic presentation device according to claim 2, comprising:
a drive section configured to drive the movable member to be moved in three axial directions perpendicular to one another.

13. The haptic presentation device according to claim 12, wherein the haptic presentation unit is configured to present a sense of force through the movable member to the area of the user's finger with which the movable member is in contact.

14. The haptic presentation device according to claim 3, wherein the respective haptic presentation units are configured to come in contact with any two or more areas of areas.

15. The haptic presentation device according to claim 14, wherein the any two or more areas of areas include at least a pad side, a left side, a right side, and a nail side of the user's finger held by the holding unit.

16. The haptic presentation device according to claim 15, wherein each of the respective haptic presentation units is configured to present a sense of force to an area of the any two or more areas of areas with which a corresponding haptic presentation unit is in contact.

17. The haptic presentation device according to claim 8, wherein the force sensor is disposed in an area that corresponds to at least one area of areas.

18. The haptic presentation device according to claim 17, wherein the at least one area of areas includes at least a pad side, a left side, a right side, and a nail side of the user's finger held by the holding unit.

19. The haptic presentation device according to claim 18, wherein the at least one area of areas is on a side opposite to an area where the haptic presentation unit is disposed.

20. The haptic presentation device according to claim 1, comprising a connection with an information processing apparatus in a wired or wireless manner.
